(19) United States
(12) Patent Application Publication
(10) Pub. No.: US 2023/0246231 A1
(43) Pub. Date: Aug. 3, 2023

(54) SOLID POLYMER ELECTROLYTES FOR SOLID-STATE LITHIUM METAL BATTERIES

(71) Applicants: Xiaowei Li, Philadelphia, PA (US); Yongwei Zheng, Philadelphia, PA (US); Christopher Li, Bala Cynwyd, PA (US)

(72) Inventors: Xiaowei Li, Philadelphia, PA (US); Yongwei Zheng, Philadelphia, PA (US); Christopher Li, Bala Cynwyd, PA (US)

(73) Assignee: DREXEL UNIVERSITY, Philadelphia, PA (US)

(21) Appl. No.: 18/003,512

(22) PCT Filed: Aug. 13, 2021
(86) PCT No.: PCT/US2021/045848

§ 371 Date: Dec. 28, 2022

Related U.S. Application Data
(60) Provisional application No. 63/065,412, filed on Aug. 13, 2020.

(51) Int. Cl. H01M 10/0565

(52) U.S. Cl. CPC H01M 10/0565; H01M 2300/0085; H01M 2300/0082

(57) ABSTRACT

A solid polymer electrolyte including a comb-chain crosslinked network formed by reacting poly(glycidyl methacrylate) with a functionalized poly(ethylene glycol) or functionalized poly(ethylene oxide). Batteries including the solid polymer electrolytes, a cathode, and a metal anode or one or more lithium salts are also described. A process of preparing the solid polymer electrolyte involves reacting a poly(glycidyl methacrylate) with a functionalized poly(ethylene glycol) or functionalized poly(ethylene oxide) to form a crosslinked network in a single-step polymerization process. The solid polymer electrolyte provides improved resistance to lithium dendrite formation and has excellent physical and electrical properties that make it particularly suitable for use in lithium batteries.

### CROSS REFERENCE TO RELATED APPLICATIONS

This application claims the benefit of U.S. Provisional Application No. 63/065,412, filed on Aug. 13, 2020, the entire disclosure of which is hereby incorporated by reference as if set forth fully herein.

### STATEMENT OF GOVERNMENT INTEREST

This invention was made with government support under contract nos. 1603520 and 2033882 awarded by the National Science Foundation. The Government has certain rights in the invention.

### BACKGROUND OF THE INVENTION

Lithium metal batteries (LMBs) with lithium metal as the anode are regarded as the next-generation energy storage system due to their high energy density, while the practical application is hindered by the active lithium metal/electrolytes reaction and associated morphology including lithium dendrites and orphaned lithium metal at the electrode/electrolytes interface during long cycling.¹⁻⁶ Utilizing solid polymer electrolytes (SPEs) to replace the commonly used liquid electrolytes has proved to be an effective way to suppress the lithium dendrite growth.^{2, 7, 8} Compared with liquid electrolytes, some of the crucial advantages of SPEs include leak-free, high thermal stability, flexibility, and good processability.^{2, 7-11} Tremendous efforts have been devoted to developing numerous advanced SPE systems while their lithium dendrite resistance at high current densities still needs to be further improved to render SPEs a practical choice for future LMBs.

Based on their chain architecture, reported SPEs can be divided into five categories, i.e. main-chain, side-chain, block copolymer, multiblock copolymer, and network SPEs.¹²⁻²² Studies have shown that all these architectures can be used to tune mechanical properties and ionic conductivity of the SPEs. However, symmetrical lithium cell cycling tests demonstrated that the classical main-chain, side-chain, and block copolymer SPEs suffer from poor lithium dendrite resistance, which can be attributed to their limited physical chain entanglements and that these SPEs are susceptible to plastically deform at large strain. On the other hand, network SPEs, although having a moderate shear modulus, perform the best in reported device tests,^{2, 7, 23-25} which suggests that the permanent chemical crosslinking in the network SPEs mitigates potential chain disentanglement induced by the large volume change of the electrodes during cycling and creeping, leading to enhanced device performance.

Multi-functional monomers (functionality f≥3) are typically introduced to a reaction system to form a chemically crosslinked network by either an additional chain polymerization or a step-growth polymerization mechanism.^{26, 27} For additional chain polymerization, polyethylene-poly(ethylene oxide) (PEO)-based SPEs were synthesized using ring-opening metathesis polymerization followed by hydrogenation.²⁴ Photopolymerization of acrylate-terminated PEO to form solid or gel SPEs has also been reported.^{7, 25, 28} For step-growth polymerization, epoxide-bearing polyhedral oligomeric silsesquioxane (POSS) crosslinkers have been used to crosslink diamine poly(ethylene glycol) (PEG) using a one-pot, single step polymerization procedure.^{18, 29-32} In all these SPEs, small crosslinked domains first grow and then connect to form the network. Inevitably, there is heterogeneity as the isolated cross-linked domains grow and merge into a macroscopic network (FIG. 1A). The typically small molecular mesh size associated with this method also leads to a relatively rigid network system. Designing an SPE to accommodate a large volume change, therefore, calls for a highly deformable and elastic polymer system.

Another method to form the network structure is crosslinking pre-formed polymers, such as sulfur vulcanization of natural rubber.^{26, 27} The preformed polymer ensures controlled viscosity and a uniform network structure with a large design space to tune the mesh size, elasticity, and toughness of the material as demonstrated in highly elastic and deformable polymer rubbers.

### SUMMARY OF THE INVENTION

In one aspect, the present invention relates to solid polymer electrolyte including a comb-chain crosslinked network formed by reacting poly(glycidyl methacrylate) with a functionalized poly(ethylene glycol) or functionalized poly(ethylene oxide) in the presence of one or more lithium salts.

The poly(glycidyl methacrylate) from which the solid polymer electrolyte is prepared may have from 10 to 5000 epoxide groups or 1,420 to 710,000 g/mol of molecular weight, or the poly(glycidyl methacrylate) may have from 50 to 1000 epoxide groups or 7,100 to 142,000 g/mol of molecular weight.

The solid polymer electrolyte may be made by reacting the poly(glycidyl methacrylate) with an amine-terminated diterminal functionalized poly(ethylene glycol) in the presence of one or more lithium salts. Alternatively, the solid polymer electrolyte may be prepared by reacting the poly(glycidyl methacrylate) with an amine-terminated diterminal functionalized poly(ethylene oxide) in the presence of one or more lithium salts.

The solid polymer electrolyte of any of the previous embodiments may be made by reacting the poly(glycidyl methacrylate) with the functionalized poly(ethylene glycol) or the functionalized poly(ethylene oxide) in a molar ratio between epoxide and PEG or PEO of from 1:1 to 60:1 or the solid polymer electrolyte of any of the previous embodiments may be made by reacting poly(glycidyl methacrylate) with the functionalized poly(ethylene glycol) or functionalized poly(ethylene oxide) in a molar ratio between epoxide and PEG or PEO of from 2:1 to 10:1.

The solid polymer electrolyte certain of the previous embodiments may be made by reacting the poly(glycidyl methacrylate) with an amine-terminated diterminal functionalized poly(ethylene glycol) in a molar ratio of from 2:1 to 40:1. The amine-terminated poly(ethylene glycol), has a number average molecular weight of from about 200 g/mol to about 30,000 g/mol or a number average molecular weight of from about 1,000 g/mol to about 6,000 g/mol.

The poly(glycidyl methacrylate of any of the previous embodiments may have a number average molecular weight of from about 1,420 g/mol to about 710,000 g/mol, or from about 7,100 g/mol to about 142,000 g/mol.

The solid polymer electrolyte of any of the previous embodiments may have an overall ionic conductivity of 1.3×10⁻⁴ S cm⁻¹ or greater, at 20° C. and/or a toughness as measured at 25° C. of greater than 0.1 M·J·m⁻³, or greater than 0.3 M·J·m⁻³.

In other embodiments, the present invention relates to a battery including any of the solid polymer electrolytes described above, a cathode, and a metal anode.

In other embodiments, the invention relates to a battery including any of the solid polymer electrolytes described above and one or more lithium salt(s).

In the batteries described above, the molar ratio of the monomer of the poly(ethylene glycol) or poly(ethylene oxide) to the one or more lithium salt(s) may be from 1:1 to 50:1, or from about 10:1 to 20:1, or about 16:1.

The lithium salts of the above-described batteries may have anion(s) selected from the group consisting of bis(trifluoromethanesulfonyl)imide, bis(trifluoromethane)sulfonamide, hexafluoroarsenate, hexfluorophosphate, perchlorate, tetrafluoroborate, tris(pentafluoroethyl)trifluorophosphate, trifluoromethanesulfonate, bis(fluorosulfonyl)imide, cyclo-difluoromethane-1,1-bis(sulfonyl)imide, cyclo-hexafluoropropane-1,1-bis(sulfonyl)imide, bis(perfluoroethyanesulfonyl)imide, bis(oxalate)borate, difluoro(oxalato)borate, dicyanotriazolate, tetracyanoborate, dicyanotriazolate, dicyano-trifluoromethyl-imidazole, and dicyano-pentafluoroethyl-imidazole.

The solid polymer electrolyte of any of the foregoing batteries may be a membrane having a thickness of less than 35 μm, or from about 5 μm to about 30 μm, or from about 20 μm to about 30 μm.

In another embodiment, the invention relates to a process of preparing the solid polymer electrolytes described above by reacting a poly(glycidyl methacrylate) with a functionalized poly(ethylene glycol) or functionalized poly(ethylene oxide) in the presence of one or more lithium salts to form a crosslinked network in a single-step polymerization process.

In the process of claim 18, the poly(glycidyl methacrylate) may be reacted with an amine-terminated diterminal functionalized poly(ethylene glycol).

In the process, the electrolyte may be prepared in the presence of a solvent, which is removed during/after the reaction. The solvent may be selected from the group consisting of tetrahydrofuran, diethyl ether, acetonitrile, ethyl acetate, and methyl acetate.

In the process, the electrolyte may be prepared in the presence of a lithium salt. The lithium salt may be lithium bis(trifluoromethane)sulfonimide.

In the present disclosure, following the strategy of rubber chemistry, a macromolecular crosslinker, poly(glycidyl methacrylate), with epoxy side groups is introduced to form a series of comb-chain crosslinker-based network SPEs (ConSPEs). As shown in FIG. 1B, because of the comb-chain architecture, each polymer has many epoxide functional groups for the crosslinking reaction—for a molar mass of 15,000 g mol⁻¹ poly(glycidyl methacrylate), 106 epoxide groups are available for further crosslinking/functionalization. These groups can easily react with the amine chain ends from PEG. Due to the large number of functional groups, gelation occurs much earlier in ConSPEs compared with previous reported network SPEs. According to the gelation theory, the critical branching coefficient has the following formula:

$${α}_{c} = \frac{1}{f - 1} ,$$

where f is the functionality, 8 for the previously reported POSS network SPE and 106 for the poly(glycidyl methacrylate) comb-chain crosslinker.¹⁸ α_{c} for these two networks are therefore 0.14 and 0.0095, respectively. This dramatic α_{c} difference suggests that it is much easier to gel in a ConSPE, leading to a fixed homogeneous morphology. Furthermore, the enhanced initial viscosity and retarded diffusion kinetics associated with the large molar mass of comb-chain crosslinker delay phase separation and a homogeneous phase will be more readily obtained in the ConSPEs. Meanwhile, the flexibility of the poly(glycidyl methacrylate) chains further enhances the toughness of the ConSPE membranes.

SPEs are a promising approach to realize practical dendrite-free lithium metal batteries. Tuning the nanoscale polymer network chemistry is important for SPE design. In the present disclosure, a series of comb-chain crosslinker-based SPEs (ConSPEs) are disclosed which employ a preformed polymer as the multifunctional crosslinker. The high-functionality cross-linker increases the connectivity of nanosized cross-linked domains, which leads to a robust network with dramatically improved toughness and superior lithium dendrite resistance even at a current density of 2 mA cm⁻². The uniform and flexible network also dramatically improves the anodic stability to over 5.3 V vs. Li/Lit Additive-free, all-solid-state LMBs made with the ConSPEs showed high discharge capacity and stable cycling up to 10 C rate, and can be stably cycled at 25° C. These ConSPEs are promising for high-performance and dendrite-free LMBs.

### BRIEF DESCRIPTION OF THE DRAWINGS

FIG. 1A shows a schematic of network formed from small molar mass crosslinker (hollow circles).

FIG. 1B shows a schematic of network formed by a comb-chain crosslinker.

FIG. 2A shows a photograph of the obtained ConSPE membranes.

FIG. 2B shows another photograph of the obtained ConSPE membranes.

FIG. 2C shows a Scanning electron microscope (SEM) image of 4PGMA-PEG6k ConSPE membrane.

FIG. 3A shows Fourier Transform Infrared (FTIR) spectra of the PGMA-PEG ConSPE.

FIG. 3B shows an enlarged portion of the spectra of FIG. 3A between 550 cm⁻¹ and 1400 cm⁻¹.

FIGS. 4A-4D show thermal and electrochemical properties of PGMA-PEG ConSPEs.

FIG. 4A shows Differential scanning calorimetry (DSC) second heating thermograms.

FIG. 4B shows the temperature dependence of ionic conductivities (ionic conductivities of POSS-4PEG2k and MPEG2000 are from Refs.³⁰ and ³⁵, respectively).

FIG. 4C shows a comparison of ionic conductivities at 25° C., 40° C., and 90° C., and ethylene oxide (EO) weight percent in the network.

FIG. 4D shows linear sweep voltammetry (LSV) curves for various products (LSV curve of POSS-4PEG2k is from Ref.³⁰.)

FIG. 5 shows thermogravimetric analysis (TGA) curves of the PGMA-PEG ConSPEs.

FIG. 6 shows Fogel-Tamman-Fulcher (VTF) fitting of the temperature-dependent ionic conductivity for ConSPEs.

FIG. 7 shows the chronoamperometry profiles and the impedance responses before and after a chronoamperometry test for the symmetrical lithium cells with 4PGMA-PEG6k ConSPE at 90° C.

FIG. 8A shows stress-strain curves for 4PGMA-PEG2k at 25° C. and 90° C.

FIG. 8B shows stress-strain curves for 2PGMA-PEG2k at 25° C. and 90° C.

FIG. 8C shows stress-strain curves for 4PGMA-PEG6k at 25° C. and 90° C.

FIG. 8D shows stress-strain curves for 2PGMA-PEG6k at 25° C. and 90° C.

FIG. 9A shows the time-voltage profiles of symmetrical lithium cells with the 4PGMA-PEG6k ConSPE at 90° C. and 1 mA cm⁻² with an areal capacity of 3 mAh cm⁻².

FIG. 9B shows the time-voltage profiles of symmetrical lithium cells with the 4PGMA-PEG6k ConSPE at 90° C. and 2 mA cm⁻² with an areal capacity of 2 mAh cm⁻².

FIG. 9C shows the time-voltage profiles of symmetrical lithium cells with the 4PGMA-PEG6k ConSPE at 25° C. and 0.05 mA cm⁻² with an areal capacity of 0.05 mAh cm⁻².

FIG. 9D shows the correlation of normalized short-circuit time t_{sc} for Li/ConSPE/Li cells 9 mA cm⁻², 3 mAh cm⁻², (at least two cells were tested for each con ConSPE and the average values were used) with ConSPE toughness and modulus.

FIG. 9E shows a comparison of normalized short-circuit time t_{sc} for 4PGMA-PEG6k ConSPE developed in this work with the state-of-the-art SPEs.

FIG. 10A shows time-dependent voltage profiles of symmetrical lithium cells at 90° C. and 1 mA cm⁻² with an areal capacity of 3 mAh cm⁻² for 4PGMA-PEG2k.

FIG. 10B shows time-dependent voltage profiles of symmetrical lithium cells at 90° C. and 1 mA cm⁻² with an areal capacity of 3 mAh cm⁻² for 2PGMA-PEG2k.

FIG. 10C shows time-dependent voltage profiles of a symmetrical lithium cells at 90° C. and 1 mA cm⁻² with an areal capacity of 3 mAh cm⁻² for 2PGMA-PEG6k ConSPEs.

FIGS. 11A-11C show X-ray photoelectron spectroscopy (XPS) spectra for the lithium surface of a symmetrical Li/4PGMA-PEG6k/Li cell after cycling at 90° C. and 1 mA cm⁻² before etching with an Ar ion gun (1 kV for 1 min).

FIG. 11A shows the XPS spectra for elemental carbon before etching.

FIG. 11B shows the XPS spectra for elemental oxygen before etching.

FIG. 11C shows the XPS spectra for elemental fluorine before etching.

FIGS. 11D-11F show XPS spectra for the lithium surface of a symmetrical Li/4PGMA-PEG6k/Li cell after cycling at 90° C. and 1 mA cm⁻² after etching with an Ar ion gun (1 kV for 1 min).

FIG. 11D shows the XPS spectra for elemental carbon after etching.

FIG. 11E shows the XPS spectra for elemental oxygen after etching.

FIG. 11F shows the XPS spectra for elemental fluorine after etching.

FIGS. 12A-12G show full battery performance of ConSPE-based fuel cells.

FIG. 12A shows Li/LiFePO₄ battery performance for the 4PGMA-PEG6k ConSPE in terms of discharge capacity and Coulombic efficiency %.

FIG. 12B shows Li/LiFePO₄ battery performance for the 4PGMA-PEG6k ConSPE in terms of charge-discharge curves under different current rates at 90° C.

FIG. 12C shows Li/LiFePO₄ battery performance for the 4PGMA-PEG6k ConSPE in terms of discharge capacity and coulombic efficiency % at 90° C. under a 1C rate.

FIG. 12D shows Li/LiFePO₄ battery performance for the 4PGMA-PEG6k ConSPE in terms of discharge capacity and coulombic efficiency % at 25° C. under a 0.1 C rate.

FIG. 12E shows SEM images of lithium anode surfaces before rate tests at 90° C.

FIG. 12F-12G show SEM Images of lithium anode surfaces after rate tests at 90° C.

FIGS. 12H-12I show Li/Li/Ni_{0.6}Mn_{0.2}Co_{0.2}O₂ battery performance of 4 PGMA-PEG6k ConSPE at 90° C. under a current density of 20 mA g⁻¹.

FIG. 12H shows the discharge capacity and coulombic efficiency %.

FIG. 12I shows the charge-discharge curves for the 1^{st} and 50^{th} cycles.

FIGS. 13A-13B show Li/LiFePO₄ battery performance of 4 PGMA-PEG6k ConSPE.

FIG. 13A shows the discharge capacity and coulombic efficiency at 50° C. under different C rates.

FIG. 13B shows the charge-discharge curves at 25° C., 50° C., and 90° C.

FIG. 14A shows a schematic of network formed by a comb-chain crosslinker.

FIG. 14B shows the Li/LiFePO₄ battery performance in terms of voltage.

FIG. 14C shows the Li/LiFePO₄ battery performance in terms of discharge capacity and coulombic efficiency.

### DETAILED DESCRIPTION

Poly(glycidyl methacrylate)-based ConSPEs are synthesized using a facile one-pot method. The chemical, thermal, mechanical, and electrochemical properties of the ConSPEs are carefully characterized. The correlation between the network structure and ConSPE performance is shown by preparing a series of ConSPEs with different crosslinking densities and network mesh sizes through changing the poly(glycidyl methacrylate) monomer/PEG molar ratio and PEG molar mass, respectively. The prepared PGMA-PEG ConSPEs exhibited superior overall properties and improved LMB device performance compared with the state-of-the-art SPEs with an ionic conductivity of 1.31×10⁻⁴ S cm⁻¹ at 40° C., high electrochemical stability over 5.3 V vs. Li/Li⁺, excellent toughness, excellent lithium dendrite resistance up to 2 mA cm⁻², and superior battery performance over a wide temperature range from 25° C. to 90° C.

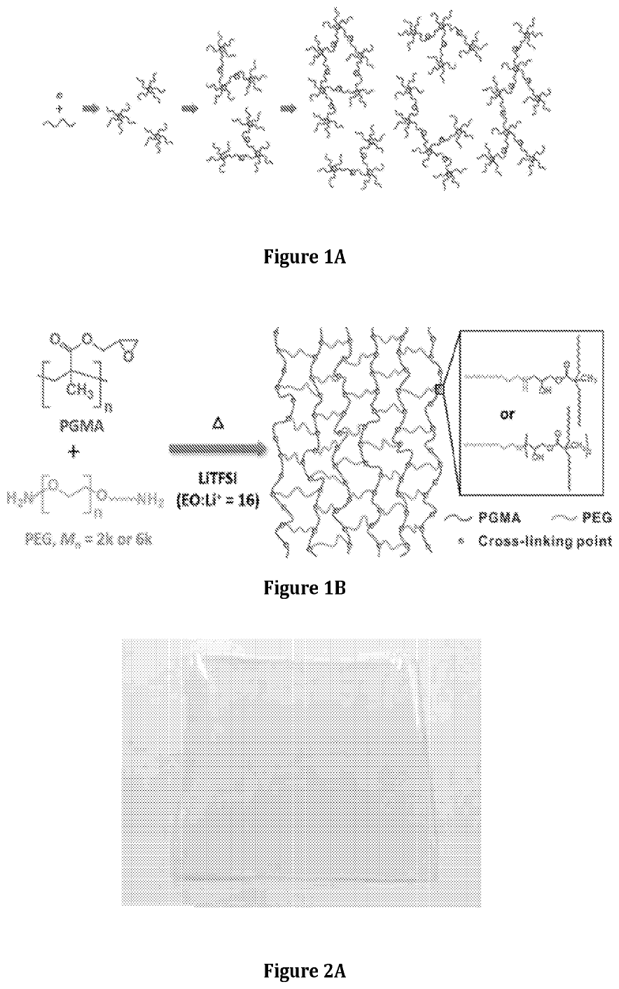

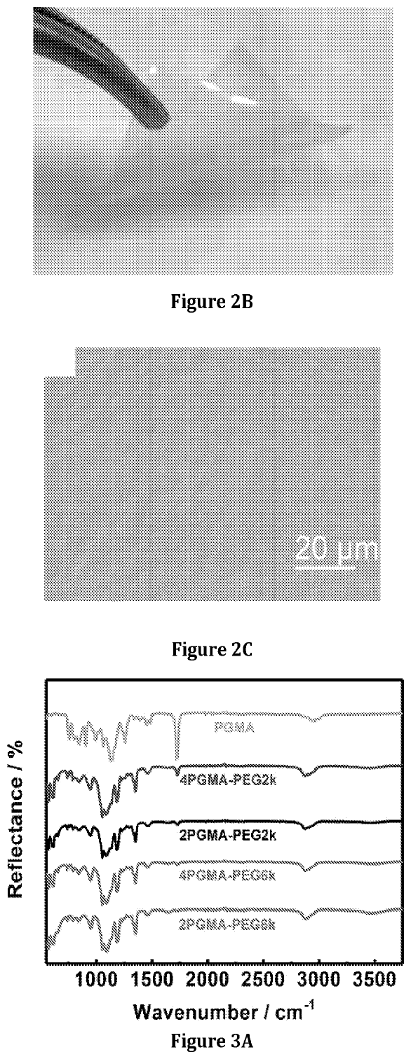

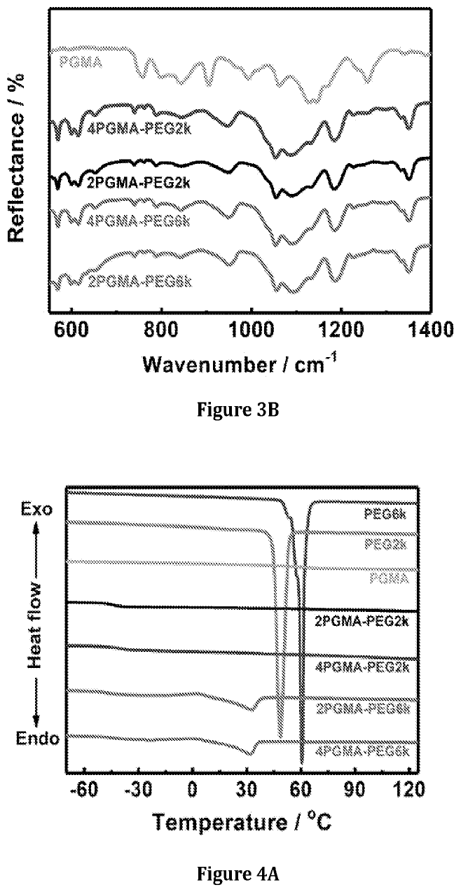

As shown in FIG. 1, the homogeneously crosslinked network of poly(glycidyl methacrylate)-PEG ConSPEs (denoted as xPGMA-PEGn, in which x denotes the molar ratio of poly(glycidyl methacrylate) monomer/PEG, and n is the PEG molar mass, as shown in Table 1) was formed by the reaction between epoxy groups from PGMA and amine groups from amine-terminated PEG. Lithium bis(trifluoromethanesulfonyl)imide (LiTFSI) (molar ratio of ethylene oxide (EO)/Li⁺=16) with high ionic conductivity and thermal stability⁹ was employed as the lithium salt. The obtained ConSPE membranes are transparent and flexible, with a smooth surface as observed from photographs and scanning electron microscopy (SEM) image in FIG. 2. Fourier transform infrared (FTIR) spectra (FIG. 3) indicate that all the ConSPE samples are highly crosslinked since the majority of epoxy groups have reacted after crosslinking.

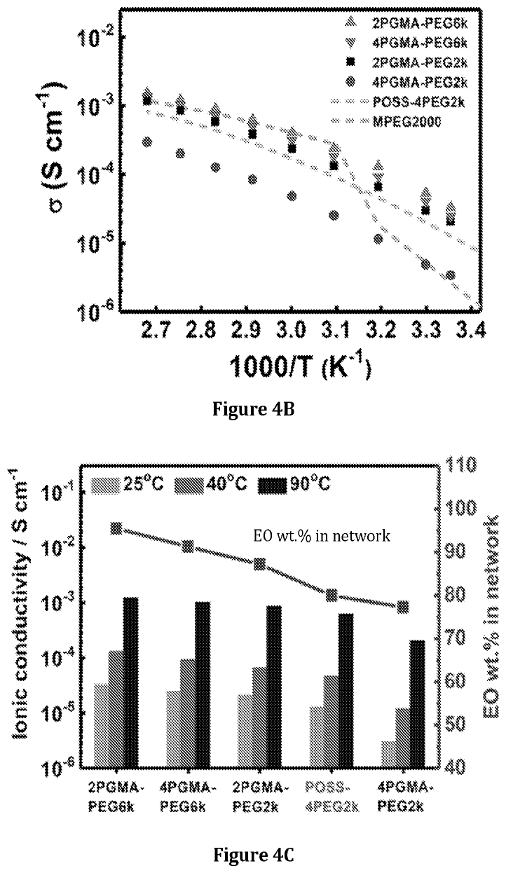

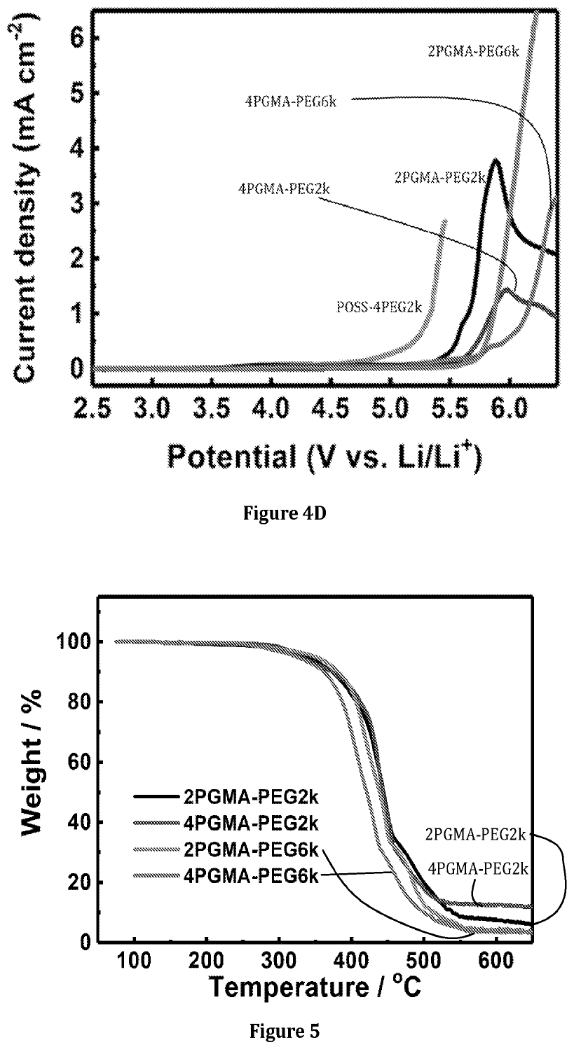

Thermal properties of the as-prepared PGMA-PEG ConSPEs were evaluated using differential scanning calorimetry (DSC) and thermal gravimetric analysis (TGA), and the results are shown in FIG. 4A and FIG. 5, respectively. The glass transition temperature, T_{g}, and the degree of crystallinity, X_{c}, of the ConSPE samples are listed in Table 1. T_{g} of PGMA homopolymer is 62° C. For ConSPEs, due to the large PEG content, PEG dominates the system. The ConSPE T_{g}s range from −47.2 to −39.1° C. and it decreases with the EO content in the network. There is no PEG crystallization peak for the two ConSPE samples with PEG2k, indicating that the PEG crystallization was completely suppressed after crosslinking. For ConSPEs with PEG6k, DSC heating curves show a recrystallization exothermic peak before crystal melting. The endothermic melting peaks are located between 32° C. and 33° C., which are much lower than the melting temperature of PEG6k homopolymer (around 60° C.). The degree of crystallinity X_{c} of ConSPE samples can be calculated from the equation

X_{c}=(ΔHₘ−ΔH_{c})/(ΔH_{m,0}×w)) (1)

in which ΔHₘ, ΔH_{c}, ΔH_{m,0} and w denote the ConSPE melting enthalpy, enthalpy of recrystallization, the melting enthalpy of a 100% crystalline form of PEO (196.6 J g⁻¹),³³ and the PEG weight percentage in the ConSPE, respectively. Relatively low X_{c}s of 14.5% and 15.6% are found for these two ConSPEs as shown in Table 1, suggesting that a small portion of the PEG is crystallized in the sample. From the TGA curves shown in FIG. 5, it can be seen that thermal decomposition temperatures T_{5%} (temperature when 5% weight loss occurs) for the PGMA-PEG ConSPEs are between 325° C. and 351° C., confirming its high thermal stability, which is crucial for high temperature applications as well as mitigating the safety hazard triggered by thermal runaway.³⁴

TABLE 1
Characteristics of PGMA-PEG ConSPEs.

| | | | | | Ionic conductivity | | | Oxidation | |
|---|---|---|---|---|---|---|---|---|---|
| | EO wt/% | EO wt/% | T_{g} | X_{c} | [mS cm⁻¹] | | | potential | |
| ConSPE | in network | in ConSPE | [° C.] | [%] | 25° C. | 40° C. | 90° C. | [V] | t_{Li+} |
| 2PGMA-PEG2k | 87.2 | 64.3 | −42.9 | — | 0.021 | 0.066 | 0.854 | 5.3 | 0.188 |
| 4PGMA-PEG2k | 77.3 | 58.6 | −39.1 | — | 0.003 | 0.012 | 0.203 | 5.5 | 0.150 |
| 2PGMA-PEG6k | 95.5 | 68.7 | −47.2 | 15.6 | 0.033 | 0.131 | 1.22 | 5.5 | 0.234 |
| 4PGMA-PEG6k | 91.3 | 66.6 | −46.0 | 14.5 | 0.025 | 0.092 | 1.02 | 5.7 | 0.172 |

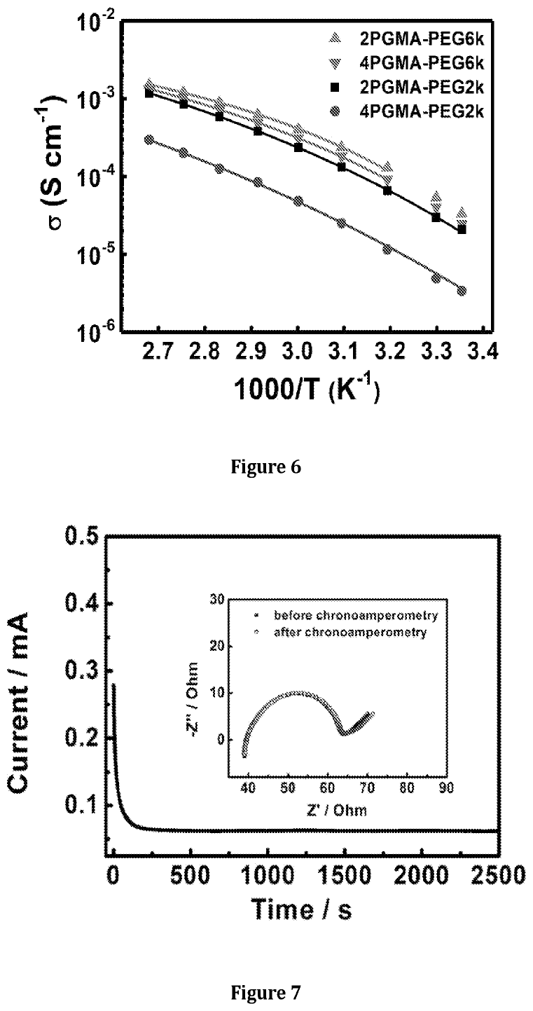

Ionic conductivities of PGMA-PEG ConSPEs were measured using AC impedance spectroscopy. FIG. 4B and Table 1 show that the ionic conductivities increase with temperature, and the curves can be fitted with the Vogel-Tammann-Fulcher (VTF) equation (FIG. 6, Table 2), demonstrating that the ion transport in PGMA-PEG ConSPEs is facilitated by polymer chain reptation.³⁶ EO weight ratio in the network and ionic conductivities at 25° C., 40° C. and 90° C. for the ConSPEs are listed and plotted in Table 1 and FIG. 4C. For all the ConSPE samples, with the increase of EO weight ratio in the network, the ionic conductivity increases and the activation energy decreases, which is because PEG acts as the lithium ion solvating medium and increasing the PEG content could decrease T_{g} and also increase the number of dissociated ions since the EO/Li molar ratio remains constant. Among all the ConSPEs, 2PGMA-PEG6k shows the highest ionic conductivity of 1.31×10⁻⁴ S cm⁻¹ at 40° C. and 1.22×10⁻³ S cm⁻¹ at 90° C., which are comparable to the state-of-the-art all-solid-state SPEs,^{18, 24} compositem^{37, 38} and plasticized^{25, 39} polymer electrolytes. Compared with poly(ethylene glycol) methyl ether (MPEG, =2k)-LiTFSI SPE,³⁵ PGMA-PEG ConSPEs show similar ionic conductivities at high temperature (≥50° C.) and one order of magnitude higher below 40° C., which is due to the suppression of PEG crystallization as confirmed by DSC results. Moreover, ionic conductivities of the previously reported POSS-4PEG2k SPE^{18, 30} are plotted in FIGS. 4B and 4C for comparison. The 2PGMA-PEG2k ConSPE with the same epoxy/amine ratio and PEG molar mass exhibits 1.3-1.8 times higher ionic conductivities than POSS-4PEG2k, which can be attributed to the higher EO weight ratio in the network (87.2% vs. 80.0% for POSS-4PEG2k).

The electrochemical stability is evaluated by linear sweep voltammetry (LSV). As shown in FIG. 4D and Table 1, compared with linear PEO-based SPEs and POSS-4PEG2k SPE (4-4.5 V),^{30, 40} the anodic stability of the ConSPEs dramatically enhances to over 5.3 V vs. Li/Li⁺, and increases with the increase of PGMA content, which could be attributed to the robust cross-linking network structure and the ester groups in PGMA that act as a protective layer for EO groups.⁴¹ The higher anodic stability of ConSPEs with PEG6k compared to those with PEG2k is likely due to less terminal groups that are unstable at high voltage.⁴² The remarkable electrochemical stability enables the combination of ConSPEs with high-voltage cathodes (LiNiₓMn_{y}Co_{1-x-y}O₂, LiCoO₂, et al.) for high-energy-density LMBs. The lithium ion transference numbers t_{Li+} of PGMA-PEG ConSPEs are between 0.150 and 0.234 (FIG. 7, Table 1), which are typical for PEO-based SPEs.^{8, 18, 43}

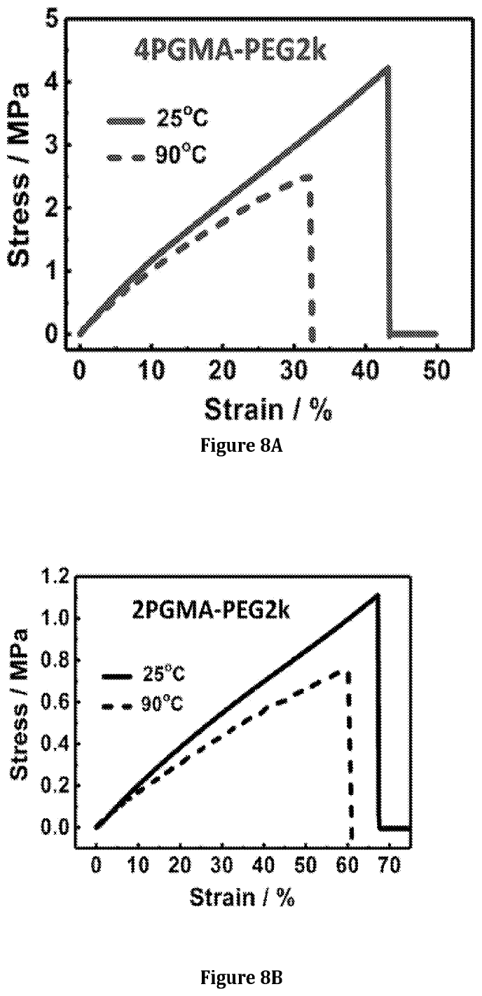

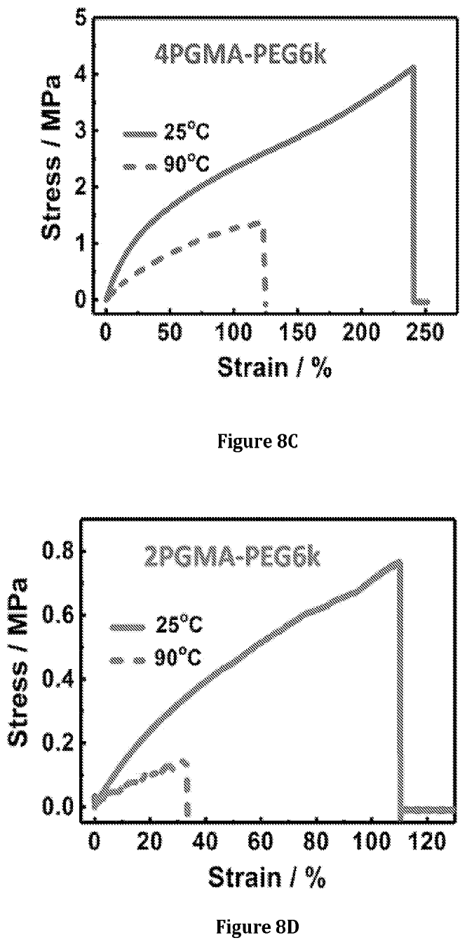

Sufficient mechanical strength is essential for successful battery applications and lithium dendrite growth resistance⁴⁴ during repeated cycling in LMBs. The mechanical properties of PGMA-PEG ConSPEs were investigated by tensile tests at both 25° C. and 90° C., and the results are shown in FIG. 8 and Table 3. For ConSPEs with PEG2k, there is no significant change from 25° C. to 90° C. since PEG crystallization is completely suppressed. While for ConSPEs with PEG6k, due to partial crystallization of PEG, the modulus and toughness decrease when the temperature rises to 90° C. When increasing the PEG molar mass from 2k to 6k g mol⁻¹, ConSPE modulus decreases while its elongation-at-break and toughness significantly increase. 4PGMA-PEG6k ConSPE shows the highest toughness at both 25° C. and 90° C. The mechanical properties of the POSS-PEG SPE are also listed in Table 3 for comparison. The toughness of 2PGMA-PEG2k ConSPE is 5.6 times that of the POSS-4PEG2k SPE with the same epoxy/amine ratio and PEG molar mass, which confirms our strategy that employing high-functionality PGMA as the crosslinker would generate a more robust network.

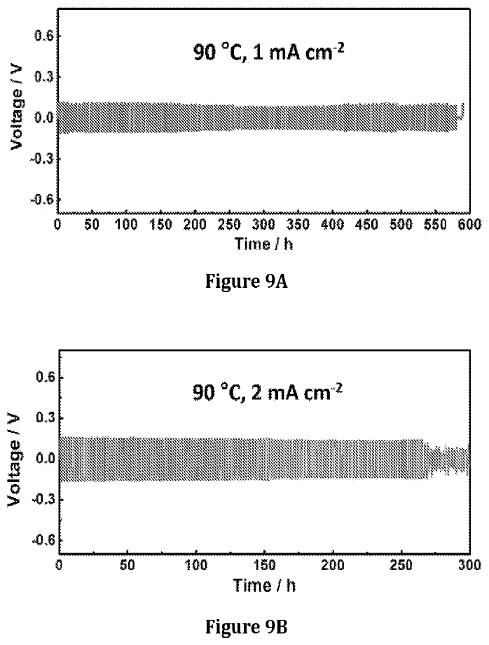

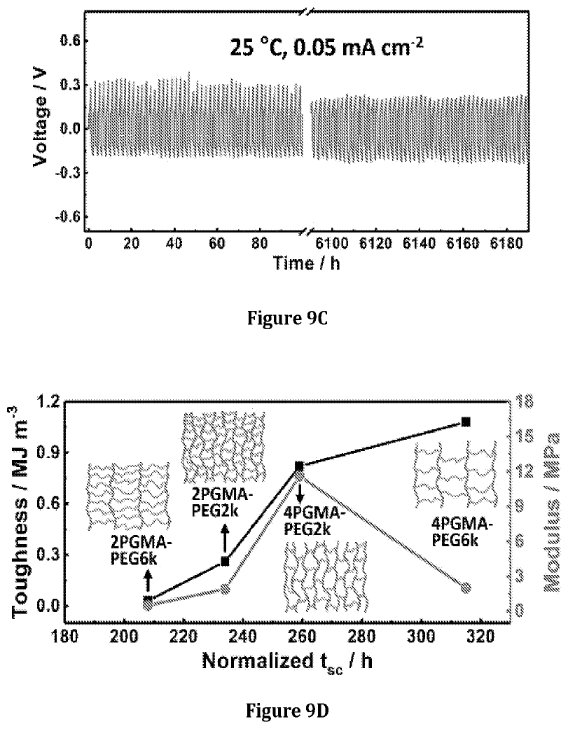

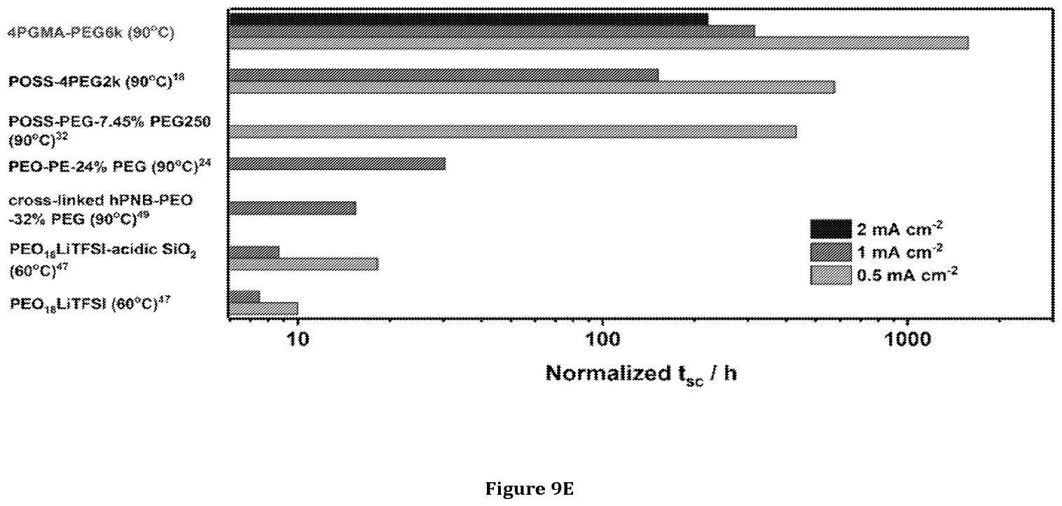

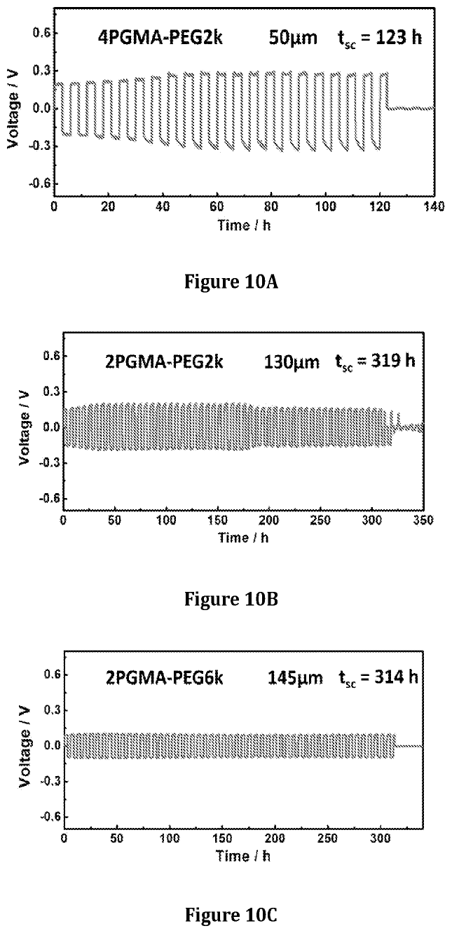

Lithium plating-stripping tests were employed to evaluate the lithium deposition stability and the lithium dendrite resistance of the PGMA-PEG ConSPEs. As shown in FIG. 9, symmetrical lithium cells with the 4PGMA-PEG6k ConSPE exhibits a short circuit time t_{sc} of 580 h when cycled at 90° C. under the current density of 1 mA cm⁻² with an areal capacity of 3 mAh cm⁻², and 266 h under 2 mA cm⁻² with 2 mAh cm⁻². Even at 25° C., the cell is able to deliver stable cycling under the current density of 0.05 mA cm⁻² with the areal capacity of 0.05 mAh cm⁻² for over 6000 h, indicating high stability with lithium and excellent lithium dendrite resistance of the ConSPE. FIG. 10 shows the time-voltage profiles for the other three ConSPEs. All samples exhibit stable lithium plating-stripping behavior over 100 h at 90° C. under 1 mA cm⁻² with the areal capacity of up to 3 mAh cm⁻². In the previous study, t_{sc} is proved to be proportional to the SPE thickness.⁴⁵ Therefore, the t_{sc} values from previous literatures and in this work are normalized using a thickness of 100 μm as the benchmark. While plotting normalized t_{sc} versus ConSPE modulus, a bell-shaped curve is seen in FIG. 9D, indicating an optimum modulus for cell cycling, which is consistent with our previous report.⁴⁶ The plotting of normalized t_{sc} versus ConSPE toughness (FIG. 9D) indicates that the normalized t_{sc} monotonically increases from 208 h to 315 h as the ConSPE toughness changed from 0.03 to 1.08 MJ m⁻³. This confirms our hypothesis that rather than modulus, toughness which reflects both strength and extensibility³⁹ plays an important role in lithium dendrite resistance.

The short circuit time t_{sc} of ConSPEs is compared with the previously reported SPEs with different molecular architectures, as shown in FIG. 9E. The 4PGMA-PEG6k ConSPE shows better performance than linear PEO SPEs,⁴⁷ copolymer SPEs^{20, 48} and other cross-linked SPEs.^{18, 24, 30, 32, 49} In particular, it demonstrates impressive performance at a high current density, which is desired for future LMB applications.

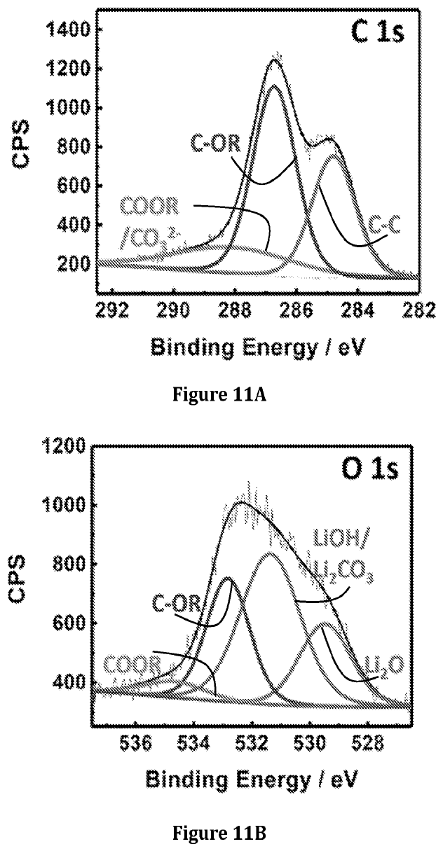

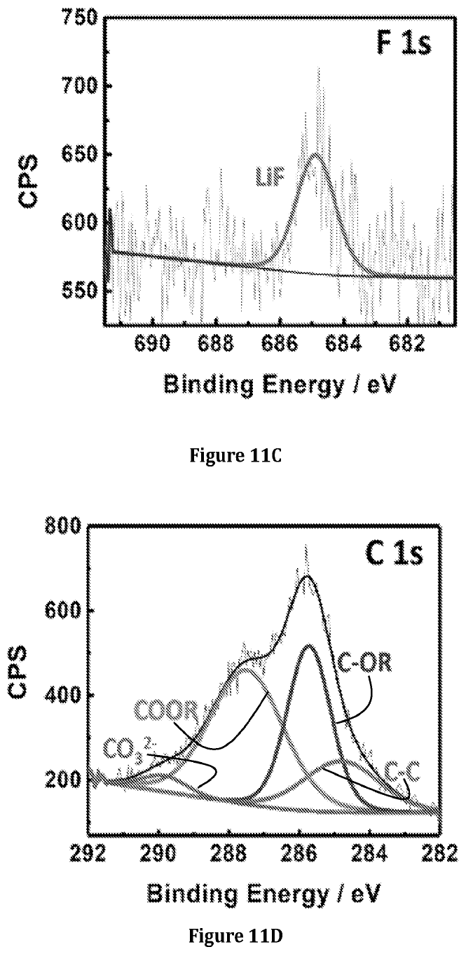

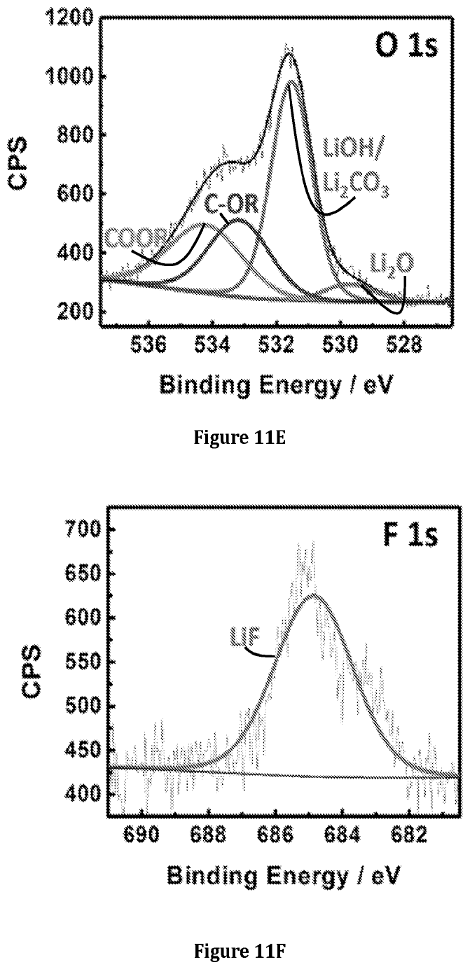

The surface chemistry of lithium in the symmetrical Li/4PGMA-PEG6k/Li cell after cycling was examined by X-ray photoelectron spectroscopy (XPS), and the spectra for C 1s, O 1s, and F is are shown in FIG. 11. The signals for N 1s and S 2p are too weak to be analyzed. The lithium surface contains similar components (C—C, C—OR, LiF, Li—OR, Li₂CO₃) to Li/PEO-LiTFSI SPE surface⁵⁰ with strong LiF and Li₂CO₃ signals and less salt degradation products (Li₂S, Li₂S₂, Li₂SO₃, Li₃N) compared to Li/POSS-PEG SPE surface,⁴⁶ which is attributed to the more integrated and robust PGMA-PEG network. Compared with the spectra before etching, the spectra after etching with Ar ion gun (1 kV for 1 min), which correspond to the inner SEI composition, show higher content of inorganic species LiF, LiOH and Li₂CO₃, and lower content of aliphatic carbon (C—C) and ether carbon (C—OR) from the polymer, exhibiting a construction similar to the mosaic-type SEI model.⁵¹ COOR mainly derived from the decomposition of the ester group in PGMA also increases after etching, which may form a protective layer together with the inorganic species to protect the lithium anode and prevent the further decomposition of the lithium salts.

Since the 4PGMA-PEG6k ConSPE sample shows high ionic conductivity, good electrochemical stability, and outstanding mechanical strength, it was chosen for further LMB performance study. Because of the excellent mechanical toughness of the 4PGMA-PEG6k sample, an ultra-thin self-standing membrane with a thickness of about 20-30 μm was obtained. Thin SPEs are desired to improve the energy and power density of LMBs.⁵² Since there is limited room for SPE conductivity improvement due to the chain reptation nature, thinner SPE membranes with lower SPE resistance can compensate for the relatively low SPE conductivity. Current ultrathin SPE membranes are obtained using a porous fiber scaffold infiltrated with polymer electrolytes.⁵² The increased initial viscosity and chain entanglement before crosslinking of the ConSPE's of the present invention significantly improve the processability of the SPE, which enables ˜20 μm SPE fabrication.

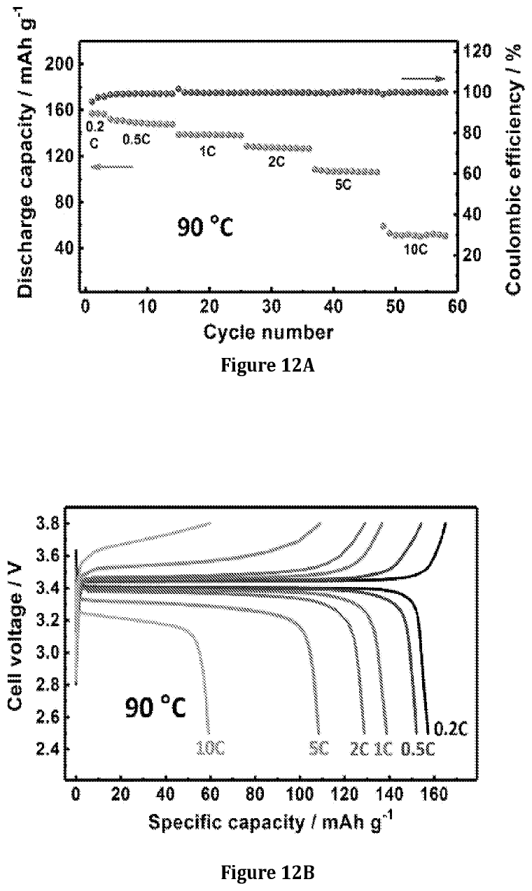

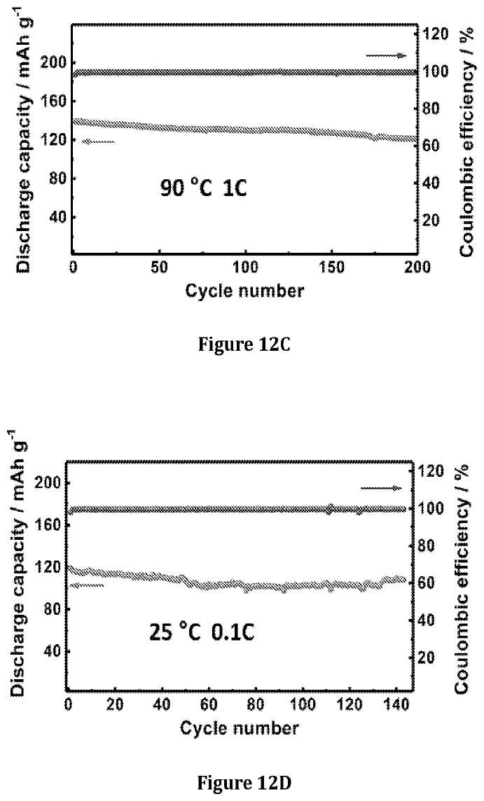

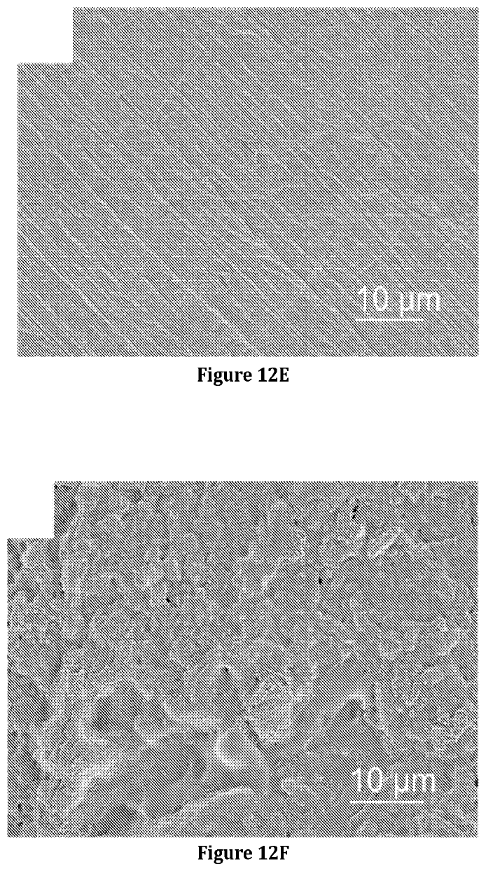

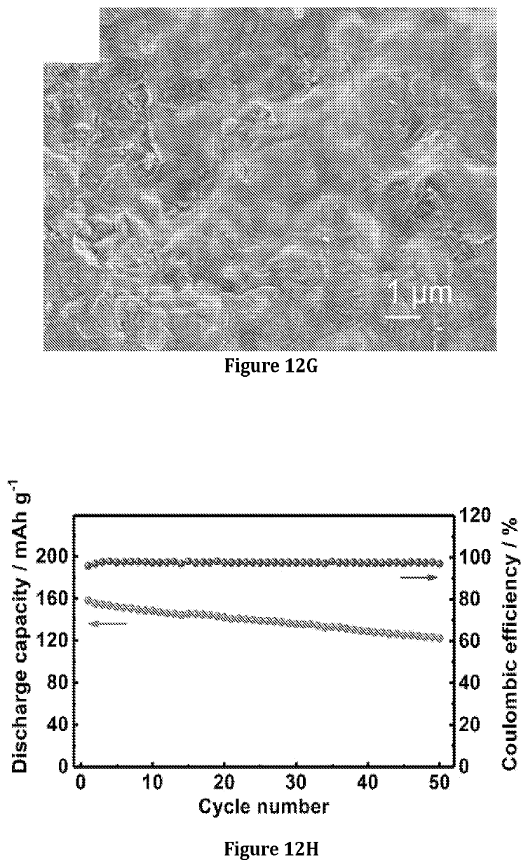

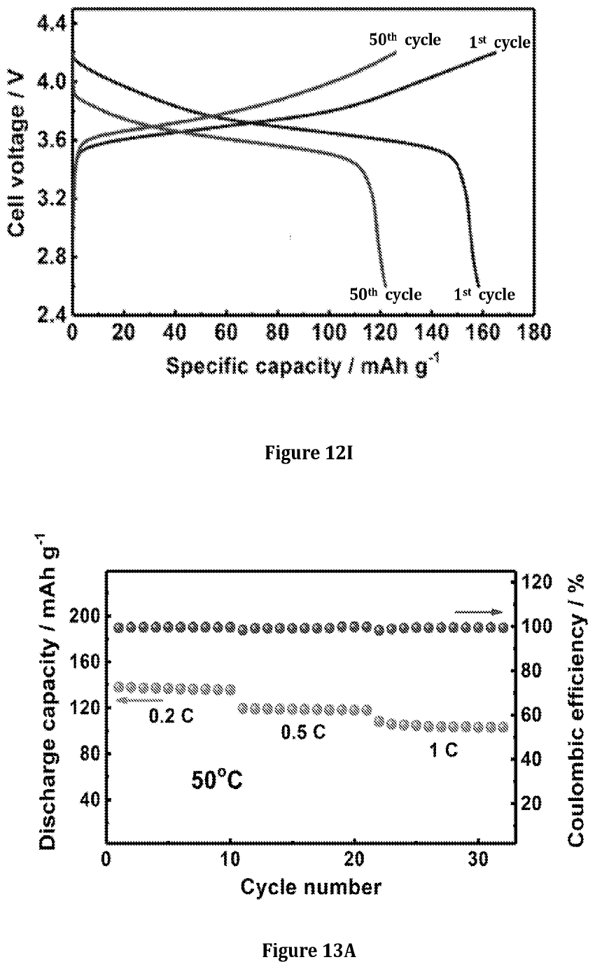

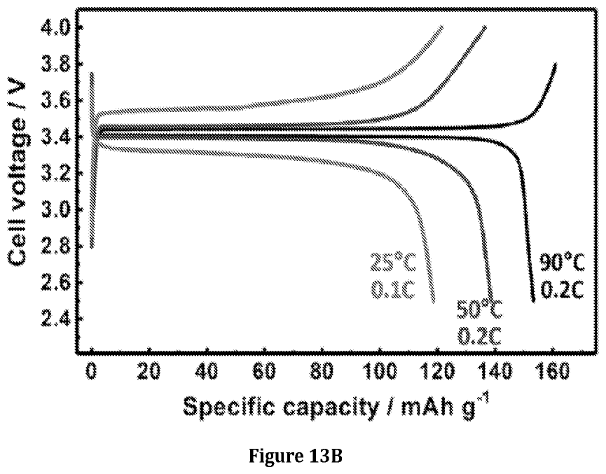

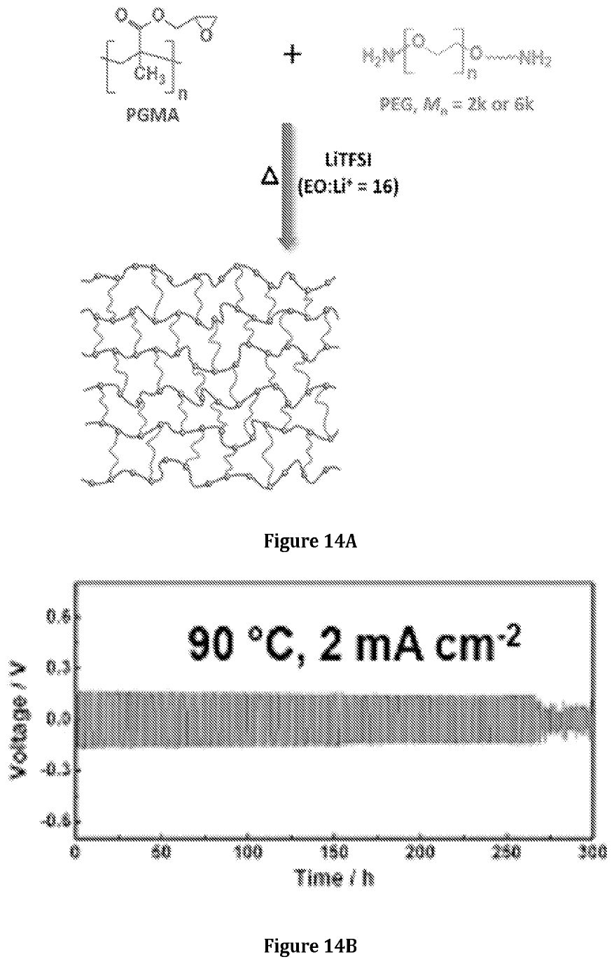

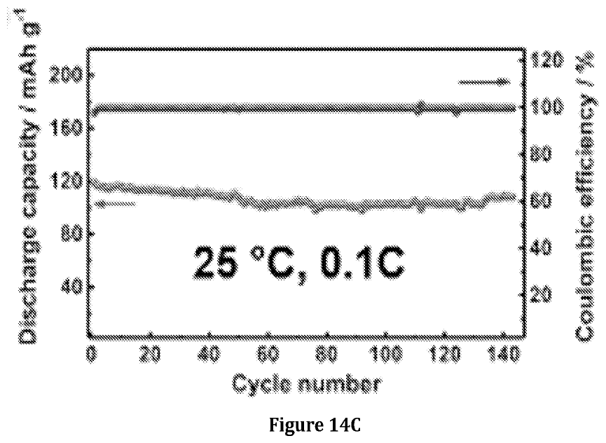

Li/LiFePO₄ batteries were assembled using the ultra-thin 4PGMA-PEG6k ConSPE sample and cycled at different temperatures. FIGS. 12A, 12B show the battery performance at 90° C. under different current rates. The battery can deliver successful cycling even when the current rate reaches up to 10 C, and the discharge capacity reaches about 157, 152, 139, 129, 108 and 59 mAh g⁻¹ under the current rates of 0.2 C, 0.5 C, 1 C, 2 C, 5 C, and 10 C, respectively, with stable cycling for each current rate. The discharge voltage plateau located at 3.4, 3.4, 3.38, 3.37, 3.3, and 3.18 V vs. Li/Li′, exhibiting typical characteristics of Li/LiFePO₄ battery.^{32, 53, 54} When cycled under a 1 C rate, the battery delivers stable discharge capacity with a capacity retention of 86.4% after 200 cycles (FIG. 12C), and the average Coulombic efficiency (CE) is 99.5%, revealing remarkable stability of the battery system. The discharge capacities for the battery at 50° C. are 138, 119, and 108 mAh g⁻¹ under 0.2 C, 0.5 C, and 1 C (FIG. 13), and remain stable in the continuous cycling. Moreover, the ultra-thin ConSPE membrane enables successful cycling at a low temperature of 25° C., with a discharge capacity of about 120 mAh g⁻¹ at 0.1 C rate, and capacity retention of 92.2% after 140 cycles. SEM images of lithium anode surface after cycling at 90° C. (FIG. 12E-12G) show a compact nodular morphology without the presence of lithium dendrites, confirming the excellent lithium dendrite resistance of ConSPEs. Compared with previously reported SPEs,^{18, 30, 46, 55-57} the ConSPE developed in this work delivers comparable or better performance at 90° C., and the discharge capacity for the ConSPE at 50° C. is even higher than the reported data obtained at 60° C.

Owing to the excellent anodic stability of 5.3 V vs. Li/Li′, the PGMA-PEG ConSPE can also achieve stable cycling for LMBs using high-voltage LiNi_{0.6}Mn_{0.2}Co_{0.2}O₂ cathode⁵⁸⁻⁶⁰ (FIGS. 12H-12I. The Li/LiNi_{0.6}Mn_{0.2}Co_{0.2}O₂ battery with the 4PGMA-PEG6k ConSPE exhibits an initial discharge capacity of about 160 mAh g⁻¹ at 90° C. under the current density of 20 mA g⁻¹, with a capacity retention close to 80% after 50 cycles, showing that the prepared PGMA-PEG ConSPEs have great potential for high-energy-density LMBs.

A series of solid polymer electrolytes were prepared using comb-chain PGMA as the crosslinker. The novel nanoscale network structure dramatically improves the network mechanical properties, which is demonstrated to be critical to lithium dendrite resistance. The ConSPEs show an impressively high ionic conductivity of 1.31×10⁻⁴ S cm⁻¹ at 40° C. with excellent thermal stability and anodic stability. Li/LiFePO₄ batteries with the ConSPE deliver high discharge capacity and good cycling performance up to 10 C rate. The battery also allows stable cycling at 25° C. In addition, stable cycling could be achieved for Li/LiNi_{0.6}Mn_{0.2}Co_{0.2}O₂ batteries with the ConSPE, exhibiting the great potential for the ConSPE in high-energy-density LMBs. These remarkable results reveal that the newly developed PGMA-PEG ConSPE is a promising electrolyte system for high-performance and dendrite-free LMBs.

### Examples

### Materials

Poly(glycidyl methacrylate) (PGMA, =15k), poly(ethylene glycol) diamine (Mₙ=2000 or 6000, PEG2k/PEG6k), lithium bis(trifluoromethane)sulfonimide (LiTFSI) and tetrahydrofuran (THF) were purchase from Aldrich. Lithium foil was purchased from Alfa Aesar. LiFePO₄ and super P conductive carbon black were obtained from MTI. LiNi_{0.6}Mn_{0.2}Co_{0.2}O₂ was synthesized using a coprecipitation and calcination method.¹ All materials were used as received.

### Preparation of PGMA-PEG ConSPEs

PGMA, PEG (2k or 6k) and LiTFSI (EO/Li=16) were dissolved in THF with different GMA/PEG molar ratio as shown in Table 1. The solution was then cast on a glass slide. After most of the solvent was slowly evaporated, the glass slide with the membrane was heated under vacuum at 90° C. for 24 h and 120° C. for over 8 h to ensure the complete reaction. The obtained membrane was transferred into the glove box for further test.

### Characterization

A Thermo Scientific Nicolet iS50 Fourier transform infrared spectroscopy (FTIR) spectrometer was used to collect FTIR spectra. Differential scanning calorimetry (DSC, TA 2000) was performed between −90 and 150° C. under the nitrogen atmosphere with a 10° C. min⁻¹ heating/cooling rate. Thermal gravimetric analysis (TGA, Perkin Elmer TGA 7) was performed with a 20° C. min⁻¹ heating rate under the nitrogen atmosphere. Tensile tests were performed with a 10 mm min⁻¹ rate, and at least three samples were tested for each ConSPE at one temperature. A Princeton Applied Research Parstat 2273 Potentiostat was employed to test the ionic conductivity using AC impedance spectroscopy with the ConSPEs sandwiched between two stainless steels. Linear sweep voltammetry (LSV) was employed at 90° C. using a 1 mV s⁻¹ rate with a stainless steel as the working electrode and a lithium foil as the reference electrode.

For the preparation of LiFePO₄ and LiNi_{0.6}Mn_{0.2}Co_{0.2}O₂ cathodes, the mixture of active material, super P and 4PGMA-PEG6k precursor in THF/H₂O with the weight ratio of 60/8/32 was cast on stainless steel, and cured under vacuum at 120° C. The active material loading is 2-3 mg cm⁻². Li/LiFePO₄ and Li/LiNi_{0.6}Mn_{0.2}Co_{0.2}O₂ batteries were assembled by placing the cathode, the ConSPE membrane and a lithium foil in sequence. The theoretical capacity of 170 mAh g⁻¹ was used to calculate the current rate for Li/LiFePO₄ batteries. The Li/LiNi_{0.6}Mn_{0.2}Co_{0.2}O₂ batteries were pre-cycled under the current density of 10 mA g⁻¹ for two cycles before cycling under 20 mA g⁻¹ between 4.2 V and 2.6 V.

As shown in the FTIR spectra, bands at 947, 1350 and 2874 cm⁻¹ belong to CH2 on PGMA and PEG chains. The band at around 1090 cm⁻¹ corresponds to the C—O—C stretching of PEG chains. The band at 1731 cm⁻¹ belongs to the C═O stretching vibration of PGMA. The bands of the TFSI anion are located at 652, 740, 789, 1054, 1184, 1228 and 1333 cm⁻¹. The broad band at 3200-3700 cm⁻¹ belongs to the N—H and O—H stretching vibration. For all the ConSPE samples, the absence of characteristic peak for the epoxy group at 910 cm⁻¹ indicates that most of the epoxy groups have reacted.

The temperature-dependent ionic conductivities for ConSPEs are fitted by Vogel-Tammann-Fulcher (VTF) equation σ=A*T^{1/2}*exp(−B/(T−T₀)), shown in FIG. 6. The parameters A, B, T₀, and activation energy Eₐ are listed in Table 2. For 2PGMA-PEG6k and 4PGMA-PEG6k, since the ConSPEs melted at about 30° C., the VTF fitting was conducted between 40° C. and 100° C.

TABLE 2
VTF fitting parameters of the ConSPE samples.

| ConSPE | A (S cm⁻¹ K^{1/2}) | B (K) | T₀ (K) | Eₐ (kJ mol⁻¹) |
|---|---|---|---|---|
| 2PGMA-PEG2k | 6.52 | 988.6 | 198.2 | 8.2 |
| 4PGMA-PEG2k | 13.10 | 1574.5 | 169.6 | 13.1 |
| 2PGMA-PEG6k | 0.64 | 399.6 | 243.1 | 3.3 |
| 4PGMA-PEG6k | 1.79 | 638.9 | 222.0 | 5.3 |

TABLE 3
Mechanical properties of PGMA-PEG ConSPEs.

| | | Young's | Tensile | | |
|---|---|---|---|---|---|
| | | modulus/ | strength/ | Elongation | Toughness/ |
| | ConSPE | MPa | MPa | at break/% | MJ m⁻³ |
| 25° C. | 2PGMA-PEG2k | 2.2 | 1.0 | 65 | 0.39 |
| | 4PGMA-PEG2k | 12.6 | 4.3 | 54 | 1.33 |
| | 2PGMA-PEG6k | 1.6 | 0.8 | 95 | 0.50 |
| | 4PGMA-PEG6k | 3.4 | 3.5 | 238 | 4.60 |
| | POSS-4PEG2k | 2.3 | 0.5 | 25 | 0.07 |
| 90° C. | 2PGMA-PEG2k | 1.9 | 0.7 | 60 | 0.26 |
| | 4PGMA-PEG2k | 11.6 | 3.2 | 37 | 0.82 |
| | 2PGMA-PEG6k | 0.5 | 0.1 | 28 | 0.03 |
| | 4PGMA-PEG6k | 2.0 | 1.3 | 129 | 1.08 |
| | POSS-4PEG2k | 2.2 | 0.4 | 21 | 0.05 |

### REFERENCES

(1) Armand, M.; Tarascon, J. M., Building better batteries. Nature 2008, 451 (7179), 652-657.
(2) Tikekar, M. D.; Choudhury, S.; Tu, Z.; Archer, L. A., Design Principles for Electrolytes and Interfaces for Stable Lithium-Metal Batteries. Nat. Energy 2016, 1 (9), 16114.
(3) Lin, D.; Liu, Y.; Cui, Y., Reviving the Lithium Metal Anode for High-Energy Batteries. Nat. Nanotechnol. 2017, 12, 194-206.
(4) Cheng, X.-B.; Zhang, R.; Zhao, C.-Z.; Zhang, Q., Toward Safe Lithium Metal Anode in Rechargeable Batteries: A Review. Chem. Rev. 2017, 117 (15), 10403-10473.
(5) Liu, J.; Bao, Z.; Cui, Y.; Dufek, E. J.; Goodenough, J. B.; Khalifah, P.; Li, Q.; Liaw, B. Y.; Liu, P.; Manthiram, A.; Meng, Y. S.; Subramanian, V. R.; Toney, M. F.; Viswanathan, V. V.; Whittingham, M. S.; Xiao, J.; Xu, W.; Yang, J.; Yang, X.-Q.; Zhang, J.-G., Pathways for practical high-energy long-cycling lithium metal batteries. Nat. Energy 2019, 4 (3), 180-186.
(6) Zhao, Q.; Stalin, S.; Zhao, C.-Z.; Archer, L. A., Designing solid-state electrolytes for safe, energy-dense batteries. Nat. Rev. Mater. 2020, 5 (3), 229-252.
(7) Choudhury, S.; Stalin, S.; Vu, D.; Warren, A.; Deng, Y.; Biswal, P.; Archer, L. A., Solid-state polymer electrolytes for high-performance lithium metal batteries. Nat. Commun. 2019, 10 (1), 4398.
(8) Lopez, J.; Mackanic, D. G.; Cui, Y.; Bao, Z., Designing polymers for advanced battery chemistries. Nat. Rev. Mater. 2019, 4 (5), 312-330.
(9) Fan, L.; Wei, S.; Li, S.; Li, Q.; Lu, Y., Recent Progress of the Solid-State Electrolytes for High-Energy Metal-Based Batteries. Adv. Energy Mater. 2018, 8 (11), 1702657.
(10) Manthiram, A.; Yu, X.; Wang, S., Lithium battery chemistries enabled by solid-state electrolytes. Nat. Rev. Mater. 2017, 2 (4), 16103.
(11) Li, X.; Cheng, S.; Zheng, Y.; Li, C. Y., Morphology control in semicrystalline solid polymer electrolytes for lithium batteries. Mol. Syst. Des. Eng. 2019, 4 (4), 793-803.
(12) Armand, M., The history of polymer electrolytes. Solid State Ionics 1994, 69 (3), 309-319.
(13) Hallinan, D. T.; Balsara, N. P., Polymer Electrolytes. Annu. Rev. Mater. Res. 2013, 43 (1), 503-525.
(14) Choo, Y.; Halat, D. M.; Villaluenga, I.; Timachova, K.; Balsara, N. P., Diffusion and migration in polymer electrolytes. Prog. Polym. Sci. 2020, 103, 101220.
(15) Young, W.-S.; Kuan, W.-F.; Epps, I. I. I. T. H., Block copolymer electrolytes for rechargeable lithium batteries. J. Polym. Sci., Part B: Polym. Phys. 2014, 52 (1), 1-16.
(16) Cheng, S.; Smith, D. M.; Li, C. Y., How Does Nanoscale Crystalline Structure Affect Ion Transport in Solid Polymer Electrolytes? Macromolecules 2014, 47 (12), 3978-3986.
(17) Cheng, S.; Smith, D. M.; Pan, Q.; Wang, S.; Li, C. Y., Anisotropic ion transport in nanostructured solid polymer electrolytes. RSC Adv. 2015, 5 (60), 48793-48810.
(18) Pan, Q.; Smith, D. M.; Qi, H.; Wang, S.; Li, C. Y., Hybrid Electrolytes with Controlled Network Structures for Lithium Metal Batteries. Adv. Mater. 2015, 27 (39), 5995-6001.
(19) Cao, C.; Li, Y.; Feng, Y.; Peng, C.; Li, Z.; Feng, W., A solid-state single-ion polymer electrolyte with ultrahigh ionic conductivity for dendrite-free lithium metal batteries. Energy Storage Mater. 2019, 19, 401-407.
(20) Huang, W.; Pan, Q.; Qi, H.; Li, X.; Tu, Y.; Li, C. Y., Poly(butylene terephthalate)-b-Poly(ethylene oxide) Alternating Multiblock Copolymers: Synthesis and Application in Solid Polymer Electrolytes. Polymer 2017, 128, 188-199.
(21) Smith, D. M.; Dong, B.; Marron, R. W.; Birnkrant, M. J.; Elabd, Y. A.; Natarajan, L. V.; Tondiglia, V. P.; Bunning, T. J.; Li, C. Y., Tuning Ion Conducting Pathways Using Holographic Polymerization. Nano Lett. 2012, 12 (1), 310-314.
(22) Smith, D. M.; Pan, Q.; Cheng, S.; Wang, W.; Bunning, T. J.; Li, C. Y., Nanostructured, Highly Anisotropic, and Mechanically Robust Polymer Electrolyte Membranes via Holographic Polymerization. Adv. Mater. Interfaces 2018, 5 (1), 1700861.
(23) Choudhury, S.; Mangal, R.; Agrawal, A.; Archer, L. A., A Highly Reversible Room-Temperature Lithium Metal Battery Based on Crosslinked Hairy Nanoparticles. Nat. Commun. 2015, 6, 10101.
(24) Khurana, R.; Schaefer, J. L.; Archer, L. A.; Coates, G. W., Suppression of Lithium Dendrite Growth Using Cross-Linked Polyethylene/Poly(ethylene oxide) Electrolytes: A New Approach for Practical Lithium-Metal Polymer Batteries. J. Am. Chem. Soc. 2014, 136 (20), 7395-7402.
(25) Mackanic, D. G.; Michaels, W.; Lee, M.; Feng, D.; Lopez, J.; Qin, J.; Cui, Y.; Bao, Z., Crosslinked Poly(tetrahydrofuran) as a Loosely Coordinating Polymer Electrolyte. Adv. Energy Mater. 2018, 8 (25), 1800703.
(26) Gu, Y.; Zhao, J.; Johnson, J. A., Polymer Networks: From Plastics and Gels to Porous Frameworks. Angew. Chem. Int. Ed. 2020, 59 (13), 5022-5049.
(27) Odian, G., Principles of Polymerization. John Wiley & Sons: 2004.
(28) Snyder, J. F.; Carter, R. H.; Wetzel, E. D., Electrochemical and Mechanical Behavior in Mechanically Robust Solid Polymer Electrolytes for Use in Multifunctional Structural Batteries. Chem. Mater. 2007, 19 (15), 3793-3801.
(29) Zheng, Y.; Pan, Q.; Clites, M.; Byles, B. W.; Pomerantseva, E.; Li, C. Y., High-Capacity All-Solid-State Sodium Metal Battery with Hybrid Polymer Electrolytes. Adv. Energy Mater. 2018, 8 (27), 1801885.
(30) Li, X.; Zheng, Y.; Pan, Q.; Li, C. Y., Polymerized Ionic Liquid-Containing Interpenetrating Network Solid Polymer Electrolytes for All-Solid-State Lithium Metal Batteries. ACS Appl. Mater. Interfaces 2019, 11 (38), 34904-34912.
(31) Zheng, Y.; Li, X.; Li, C. Y., A novel de-coupling solid polymer electrolyte via semi-interpenetrating network for lithium metal battery. Energy Storage Mater. 2020, 29, 42-51.
(32) Huang, Z.; Pan, Q.; Smith, D. M.; Li, C. Y., Plasticized Hybrid Network Solid Polymer Electrolytes for Lithium-Metal Batteries. Adv. Mater. Interfaces 2019, 6 (2), 1801445.
(33) Wunderlich, B., Thermal Analysis of Polymeric Materials. Springer Science & Business Media: 2005.
(34) Doughty, D. H.; Roth, E. P., A General Discussion of Li Ion Battery Safety. Electrochem. Soc. Interface 2012, 21 (2), 37-44.
(35) Nugent, J. L.; Moganty, S. S.; Archer, L. A., Nanoscale Organic Hybrid Electrolytes. Adv. Mater. 2010, 22 (33), 3677-3680.
(36) Lu, Y.; Das, S. K.; Moganty, S. S.; Archer, L. A., Ionic Liquid-Nanoparticle Hybrid Electrolytes and their Application in Secondary Lithium-Metal Batteries. Adv. Mater. 2012, 24 (32), 4430-4435.
(37) Zhao, C.-Z.; Zhang, X.-Q.; Cheng, X.-B.; Zhang, R.; Xu, R.; Chen, P.-Y.; Peng, H.-J.; Huang, J.-Q.; Zhang, Q., An anion-immobilized composite electrolyte for dendrite-free lithium metal anodes. Proc. Natl. Acad. Sci. 2017, 114 (42), 11069-11074.
(38) Sheng, O.; Jin, C.; Luo, J.; Yuan, H.; Huang, H.; Gan, Y.; Zhang, J.; Xia, Y.; Liang, C.; Zhang, W.; Tao, X., Mg2B2O5 Nanowire Enabled Multifunctional Solid-State Electrolytes with High Ionic Conductivity, Excellent Mechanical Properties, and Flame-Retardant Performance Nano Lett. 2018, 18 (5), 3104-3112.
(39) Mackanic, D. G.; Yan, X.; Zhang, Q.; Matsuhisa, N.; Yu, Z.; Jiang, Y.; Manika, T.; Lopez, J.; Yan, H.; Liu, K.; Chen, X.; Cui, Y.; Bao, Z., Decoupling of mechanical properties and ionic conductivity in supramolecular lithium ion conductors. Nat. Commun. 2019, 10 (1), 5384.
(40) Xu, K., Electrolytes and Interphases in Li-Ion Batteries and Beyond. Chem. Rev. 2014, 114 (23), 11503-11618.
(41) Chen, P.; Liu, X.; Wang, S.; Zeng, Q.; Wang, Z.; Li, Z.; Zhang, L., Confining Hyperbranched Star Poly(ethylene oxide)-Based Polymer into a 3D Interpenetrating Network for a High-Performance All-Solid-State Polymer Electrolyte. ACS Appl. Mater. Interfaces 2019, 11 (46), 43146-43155.
(42) Yang, X.; Jiang, M.; Gao, X.; Bao, D.; Sun, Q.; Holmes, N.; Duan, H.; Mukherjee, S.; Adair, K.; Zhao, C.; Liang, J.; Li, W.; Li, J.; Liu, Y.; Huang, H.; Zhang, L.; Lu, S.; Lu, Q.; Li, R.; Singh, C. V.; Sun, X., Determining the limiting factor of the electrochemical stability window for PEO-based solid polymer electrolytes: main chain or terminal —OH group? Energy Environ. Sci. 2020, 13 (5), 1318-1325.
(43) Gray, F. M.; Gray, F. M., Solid polymer electrolytes: fundamentals and technological applications. VCH New York: 1991.
(44) Monroe, C.; Newman, J., The Impact of Elastic Deformation on Deposition Kinetics at Lithium/Polymer Interfaces. J. Electrochem. Soc. 2005, 152 (2), A396-A404.
(45) Hallinan, D. T.; Mullin, S. A.; Stone, G. M.; Balsara, N. P., Lithium Metal Stability in Batteries with Block Copolymer Electrolytes. J. Electrochem. Soc. 2013, 160 (3), A464-A470.
(46) Pan, Q.; Barbash, D.; Smith, D. M.; Qi, H.; Gleeson, S. E.; Li, C. Y., Correlating Electrode-Electrolyte Interface and Battery Performance in Hybrid Solid Polymer Electrolyte-Based Lithium Metal Batteries. Adv. Energy Mater. 2017, 7 (22), 1701231.
(47) Liu, S.; Imanishi, N.; Zhang, T.; Hirano, A.; Takeda, Y.; Yamamoto, O.; Yang, J., Effect of Nano-Silica Filler in Polymer Electrolyte on Li Dendrite Formation in Li/Poly(ethylene oxide)-Li(CF₃SO₂)₂N/Li. J. Power Sources 2010, 195 (19), 6847-6853.
(48) Stone, G. M.; Mullin, S. A.; Teran, A. A.; Hallinan, D. T.; Minor, A. M.; Hexemer, A.; Balsam, N. P., Resolution of the Modulus versus Adhesion Dilemma in Solid Polymer Electrolytes for Rechargeable Lithium Metal Batteries. J. Electrochem. Soc. 2012, 159 (3), A222-A227.
(49) Zheng, Q.; Ma, L.; Khurana, R.; Archer, L. A.; Coates, G. W., Structure—Property Study of Cross-Linked Hydrocarbon/Poly(ethylene oxide) Electrolytes with Superior Conductivity and Dendrite Resistance. Chem. Sci. 2016, 7 (11), 6832-6838.
(50) Xu, C.; Sun, B.; Gustafsson, T.; Edstrom, K.; Brandell, D.; Hahlin, M., Interface layer formation in solid polymer electrolyte lithium batteries: an XPS study. J. Mater. Chem. A 2014, 2 (20), 7256-7264.
(51) Peled, E., Advanced Model for Solid Electrolyte Interphase Electrodes in Liquid and Polymer Electrolytes. J. Electrochem. Soc. 1997, 144 (8), L208.
(52) Wan, J.; Xie, J.; Kong, X.; Liu, Z.; Liu, K.; Shi, F.; Pei, A.; Chen, H.; Chen, W.; Chen, J.; Zhang, X.; Zong, L.; Wang, J.; Chen, L.-Q.; Qin, J.; Cui, Y., Ultrathin, flexible, solid polymer composite electrolyte enabled with aligned nanoporous host for lithium batteries. Nat. Nanotechnol. 2019, 14 (7), 705-711.
(53) Li, X.; Li, S.; Zhang, Z.; Huang, J.; Yang, L.; Hirano, S.-i., High-Performance Polymeric Ionic Liquid-Silica Hybrid Ionogel Electrolytes for Lithium Metal Batteries. J. Mater. Chem. A 2016, 4 (36), 13822-13829.
(54) Li, X.; Zhang, Z.; Li, S.; Yang, K.; Yang, L., Polymeric Ionic Liquid-Ionic Plastic Crystal All-Solid-State Electrolytes for Wide Operating Temperature Range Lithium Metal Batteries. J. Mater. Chem. A 2017, 5 (40), 21362-21369.
(55) Wang, L.; Li, X.; Yang, W., Enhancement of electrochemical properties of hot-pressed poly(ethylene oxide)-based nanocomposite polymer electrolyte films for all-solid-state lithium polymer batteries. Electrochim. Acta 2010, 55 (6), 1895-1899.
(56) Chen, Y.; Shi, Y.; Liang, Y.; Dong, H.; Hao, F.; Wang, A.; Zhu, Y.; Cui, X.; Yao, Y., Hyperbranched PEO-Based Hyperstar Solid Polymer Electrolytes with Simultaneous Improvement of Ion Transport and Mechanical Strength. ACS Appl. Energy Mater. 2019, 2 (3), 1608-1615.
(57) Hu, J.; Wang, W.; Peng, H.; Guo, M.; Feng, Y.; Xue, Z.; Ye, Y.; Xie, X., Flexible Organic-Inorganic Hybrid Solid Electrolytes Formed via Thiol-Acrylate Photopolymerization. Macromolecules 2017, 50 (5), 1970-1980.
(58) Zhang, H.; Zhang, J.; Ma, J.; Xu, G.; Dong, T.; Cui, G., Polymer Electrolytes for High Energy Density Ternary Cathode Material-Based Lithium Batteries. Electrochem. Energ. Rev. 2019, 2 (1), 128-148.
(59) Li, Z.; Xie, H.-X.; Zhang, X.-Y.; Guo, X., In situ thermally polymerized solid composite electrolytes with a broad electrochemical window for all-solid-state lithium metal batteries. J. Mater. Chem. A 2020, 8 (7), 3892-3900.
(60) Li, X.; Zheng, Y.; Li, C. Y., Dendrite-free, wide temperature range lithium metal batteries enabled by hybrid network ionic liquids. Energy Storage Mater. 2020, 29, 273-280.
(61) Ren, D.; Shen, Y.; Yang, Y.; Shen, L.; Levin, B. D. A.; Yu, Y.; Muller, D. A.; Abruña, H. D., Systematic Optimization of Battery Materials: Key Parameter Optimization for the Scalable Synthesis of Uniform, High-Energy, and High Stability LiNi_{0.6}Mn_{0.2}Co_{0.2}O₂ Cathode Material for Lithium-Ion Batteries. ACS Appl. Mater. Interfaces 2017, 9 (41), 35811-35819.

1. A solid polymer electrolyte comprising a comb-chain crosslinked network formed by reacting poly(glycidyl methacrylate) with a functionalized poly(ethylene glycol) or functionalized poly(ethylene oxide) in the presence of one or more lithium salts.

2. The solid polymer electrolyte of claim 1, wherein the poly(glycidyl methacrylate) has from 10 to 5000 epoxide groups or 1,420 to 710,000 g/mol of number average molecular weight.

3. The solid polymer electrolyte of claim 1, wherein the poly(glycidyl methacrylate) has from 50 to 1000 epoxide groups or 7,100 to 142,000 of number average molecular weight.

4. The solid polymer electrolyte of claim 1, wherein the functionalized poly(ethylene glycol) is an amine-terminated diterminal functionalized poly(ethylene glycol), and the poly(glycidyl methacrylate) is reacted with the amine-terminated diterminal functionalized poly(ethylene glycol).

5. The solid polymer electrolyte of claim 1, wherein the functionalized poly(ethylene oxide) is an amine-terminated diterminal functionalized poly(ethylene oxide), and the poly(glycidyl methacrylate) is reacted with the amine-terminated diterminal functionalized poly(ethylene oxide).

6. The solid polymer electrolyte of claim 1, where poly(glycidyl methacrylate) is reacted with the functionalized poly(ethylene glycol) or the functionalized poly(ethylene oxide) in a molar ratio between epoxide and PEG or PEO of from 1:1 to 60:1.

7. The solid polymer electrolyte of claim 1, where poly(glycidyl methacrylate) is reacted with the functionalized poly(ethylene glycol) or functionalized poly(ethylene oxide) in a molar ratio between epoxide and PEG or PEO of from 2:1 to 10:1.

8. The solid polymer electrolyte of claim 1, where the functionalized poly(ethylene glycol) is an amine-terminated diterminal functionalized poly(ethylene glycol), and the poly(glycidyl methacrylate) is reacted with the amine-terminated diterminal functionalized poly(ethylene glycol) in a molar ratio between epoxide and PEG or PEO of from 2:1 to 40:1.

9. The solid polymer electrolyte of claim 8, wherein the amine-terminated diterminal functionalized poly(ethylene glycol), has a number average molecular weight of from about 200 g/mol to about 30,000 g/mol.

10. The solid polymer electrolyte of claim 8, wherein the amine-terminated diterminal functionalized poly(ethylene glycol), has a number average molecular weight of from about 1,000 g/mol to about 6,000 g/mol.

11. The solid polymer electrolyte of claim 1, wherein the poly(glycidyl methacrylate has a number average molecular weight of from about 1,420 to about 710,000 g/mol, or from about 7,100 to about 142,000 g/mol.

12. The solid polymer electrolyte of claim 1, wherein an overall ionic conductivity of the solid polymer electrolyte is 1.3×10⁻⁴ S cm⁻¹ or greater, at 20° C. and the solid polymer electrolyte has a toughness as measured at 25° C. of greater than 0.1 M·J·m³.

13. A battery comprising the solid polymer electrolyte of claim 1, a cathode, and a metal anode.

14. A battery comprising the solid polymer electrolyte of claim 1 and one or more lithium salts.

15. The battery of claim 14, wherein a molar ratio of epoxide groups of the poly(glycidyl methacrylate) to the one or more lithium salts is from 1:1 to 20:1.

16. The battery of claim 14, wherein the one or more lithium salts have anion(s) selected from the group consisting of bis(trifluoromethanesulfonyl)imide, bis(trifluoromethane)sulfonamide, hexafluoroarsenate, hexfluorophosphate, perchlorate, tetrafluoroborate, tris(pentafluoroethyl)trifluorophosphate, trifluoromethanesulfonate, bis(fluorosulfonyl)imide, cyclo-difluoromethane-1,1-bis(sulfonyl)imide, cyclo-hexafluoropropane-1,1-bis(sulfonyl)imide, bis(perfluoroethyanesulfonyl)imide, bis(oxalate)borate, difluoro(oxalato)borate, dicyanotriazolate, tetracyanoborate, dicyanotriazolate, dicyano-trifluoromethyl-imidazole, and dicyano-pentafluoroethyl-imidazole.

17. The battery of claim 13, wherein the solid polymer electrolyte is a membrane having a thickness of less than 35 μm.

18. A process of preparing the solid polymer electrolyte of claim 1, comprising reacting the poly(glycidyl methacrylate) with the functionalized poly(ethylene glycol) or the functionalized poly(ethylene oxide) in the presence of one or more lithium salts to form a crosslinked network in a single-step polymerization process.

19. The process of claim 18, wherein the functionalized poly(ethylene glycol) is an amine-terminated diterminal functionalized poly(ethylene glycol), and the poly(glycidyl methacrylate) is reacted with the amine-terminated diterminal functionalized poly(ethylene glycol).

20. The process of claim 18, wherein the solid polymer electrolyte is prepared in the presence of a solvent, which is removed during/after the reaction, the solvent is selected from the group consisting of tetrahydrofuran, diethyl ether, acetonitrile, ethyl acetate, and methyl acetate and the electrolyte is prepared in the presence of lithium bis(trifluoromethane)sulfonimide.

21-23. (canceled)
